(19) United States
(12) Patent Application Publication
(10) Pub. No.: US 2007/0136604 A1
(43) Pub. Date: Jun. 14, 2007

(54) METHOD AND SYSTEM FOR MANAGING SECURE ACCESS TO DATA IN A NETWORK

(75) Inventors: Douglas A. Kuhlman, Inverness, IL (US); Yi Q. Li, Skokie, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/275,052

(22) Filed: Dec. 6, 2005

(51) Int. Cl. H04K 1/00

(52) U.S. Cl. 713/186

(57) ABSTRACT

Methods and system for managing secure access to data by a user in a network are disclosed. The method includes receiving (402, 404) a key and a biometric sample of the user transmitted by a user device (104) at a server (102). The method also includes decrypting (406) an encrypted biometric profile (212) corresponding to the user by using the key, to yield an unencrypted biometric profile. The method further includes authenticating (408) the user by using the biometric sample of the user and the unencrypted biometric profile corresponding to the user. The method further includes discarding (410) the key, the biometric sample of the user, and the unencrypted biometric profile corresponding to the user after authentication.

### FIELD OF THE INVENTION

The present invention relates in general to the field of networks and more specifically to managing secure access to data in a network.

### BACKGROUND OF THE INVENTION

Authentication is the foundation of security systems. It refers to methods used for verifying authenticity of a user. These authentication methods can be used in a security system to associate a unique identity with a user. A critical requirement for authentication in a security system is that while authenticating, the security system must unambiguously associate a user with his identity.

Credentials are required to verify a user. Credentials comprise information that can only be provided by the user. Examples of credentials include user passwords, user personal identification numbers (PINs), user identification cards, and tokens. Passwords are the most common form of authentication used in many security systems. Tokens are also widely used for user authentication. Tokens that are designed for authentication include information that establishes the user's identity. The user must demonstrate physical possession of the token when requested. However, passwords and tokens can be easily stolen. In this case, the person in possession of the password or token can breach the concerned security system. Further, a password may be forgotten in an infrequent and stressful situation. Recently, other credentials, such as biometrics, have become a preferred method of authentication. Biometrics authentication is an automated method for the identification and verification of users by means of their physical or behavioral characteristics. Examples of physical characteristics include face, fingerprints and iris patterns, whereas examples of behavioral characteristics are gait and signature.

Currently, there are methods available for authenticating users in a network based on their biometric information. One of these methods involves maintaining an encrypted database of biometric credentials of users on a server. A decryption key, for decrypting the encrypted database, is also kept at the server. Another method involves storing the biometric information about the user in a device present at the user end and utilizing the biometric information to establish the user's identity. Yet another method involves avoiding revealing biometric information about the user to the server by means of a user device. This is achieved by the user device performing the authentication, by matching modified versions of the biometric information, and not the actual biometric information, at the user's end.

However, one or more of the methods described above have one or more of the following limitations. First, the server with the encrypted database is susceptible to attacks by hackers. Since the decryption key is present on the server, the decryption key and the information with the server may get stolen. Second, the use of a device that stores the biometric information is not suitable for high-security applications, since the server administrator can maintain better control over a system when the credentials are stored on the server. Further, device compromise is a significant concern. Third, systems in which user authentication is performed by matching modified versions of the biometric information at a server suffer from reverse engineering attacks, in that illegitimate parties have demonstrated the ability to recover the raw information from the modified versions. Finally, all existing systems are susceptible to compromise if either the server or the device storing the biometric information is hacked.

### BRIEF DESCRIPTION OF THE FIGURES

In the accompanying figures, like reference numerals refer to identical or functionally similar elements throughout the separate views. These, together with the detailed description below, are incorporated in and form part of the specification, and serve to further illustrate the embodiments and explain various principles and advantages, in accordance with the present invention.

FIG. 1 illustrates an environment where various embodiments of the present invention can be practiced;

FIG. 2 illustrates a block diagram of a server, in accordance with an embodiment of the present invention;

FIG. 3 illustrates a block diagram of a user device, in accordance with an embodiment of the present invention;

FIG. 4 is a flowchart illustrating a method for managing secure access to data by a server in a network, in accordance with an embodiment of the present invention;

FIG. 5 is a flowchart illustrating a method for securely accessing data by a user device in a network, in accordance with an embodiment of the present invention; and

FIG. 6 illustrates an environment where various embodiments of the present invention can be practiced

Skilled artisans will appreciate that elements in the figures are illustrated for simplicity and clarity and have not necessarily been drawn to scale. For example, the dimensions of some of the elements in the figures may be exaggerated relative to other elements, to help in improving an understanding of various embodiments of the present invention.

### DETAILED DESCRIPTION

Before describing in detail the particular method and system for managing secure access to data by a user in a network in accordance with the present invention, it should be observed that the present invention resides primarily in combinations of method steps and system components related to use of biometric information to manage secure access to the data. Accordingly, the system components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as first and second, and the like may be used solely to distinguish one entity or action from another entity or action without necessarily requiring or implying any actual such relationship or order between such entities or actions. The terms ‘comprises,’ ‘comprising,’ or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by ‘comprises . . . a’ does not, without more constraints, preclude the existence of additional identical elements in the process, method, article, or apparatus that comprises the element.

The present invention describes a method for managing secure access to data by a user in a network. The method involves using biometric information of the user to gain access to the data. The method includes receiving a key from a user device for creating an unencrypted biometric profile of the user from a database of encrypted biometric profiles. More specifically, a stored encrypted biometric profile corresponding to the user is decrypted using the key to yield the unencrypted biometric profile. The method also includes receiving a biometric sample of the user and authenticating the user using the unencrypted biometric profile and the biometric sample. Moreover, the method includes discarding the key, the biometric sample, and the unencrypted biometric profile after authenticating the user.

The present invention further describes a method used in a user device. The method includes transmitting a key to a server. The method also includes transmitting a biometric sample of a user to the server for authentication.

Moreover, the present invention describes a server for managing secure access to data in a network. The server includes a means for communicating, a memory, a processor, a database of encrypted biometric profiles, and an authentication unit. The memory stores a key and a biometric sample received from the user. The processor is capable of accessing the database of encrypted biometric profiles. The processor is also capable of using the key to decrypt an encrypted biometric profile corresponding to the user, to yield an unencrypted biometric profile. The authentication unit is capable of authenticating the user by using the biometric sample and the unencrypted biometric profile.

The present invention also describes a user device. The user device includes a transceiver and a means to access data. The transceiver is configured to transmit a key and a biometric sample of the user to the server.

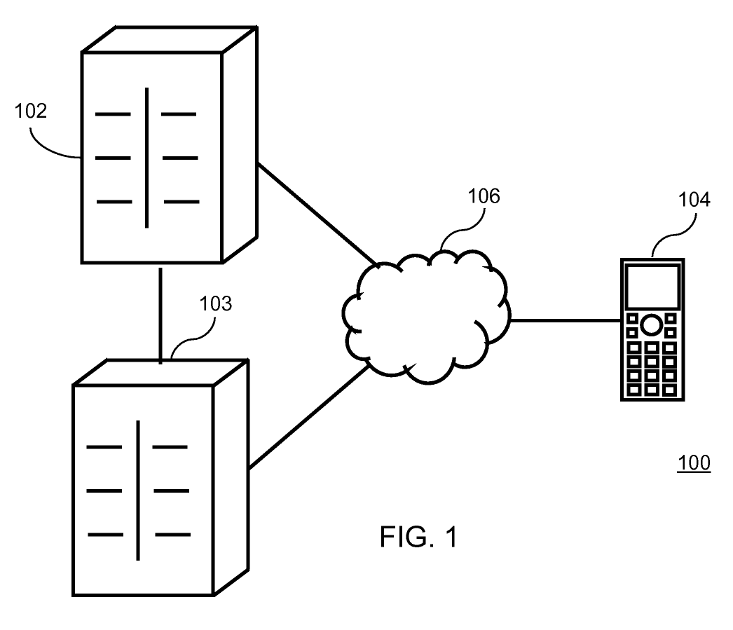

FIG. 1 illustrates an environment 100, where various embodiments of the present invention can be practiced. The environment 100 includes at least one server 102 and a user device 104, connected by a communication link 106. Other servers may be linked to server 102, as exemplified by server 103. The linkage may be direct or through the communication link 106. Examples of the communication link 106 include, but are not limited to, a wireless communication link, a cellular link, and the Internet. Examples of the user device 104 include, but are not limited to, a wireless communication device such as a mobile phone, a Personal Digital Assistant (PDA), and a laptop or desktop computer. The user device 104 interacts with the server 102 to determine access to data stored on the server 102.

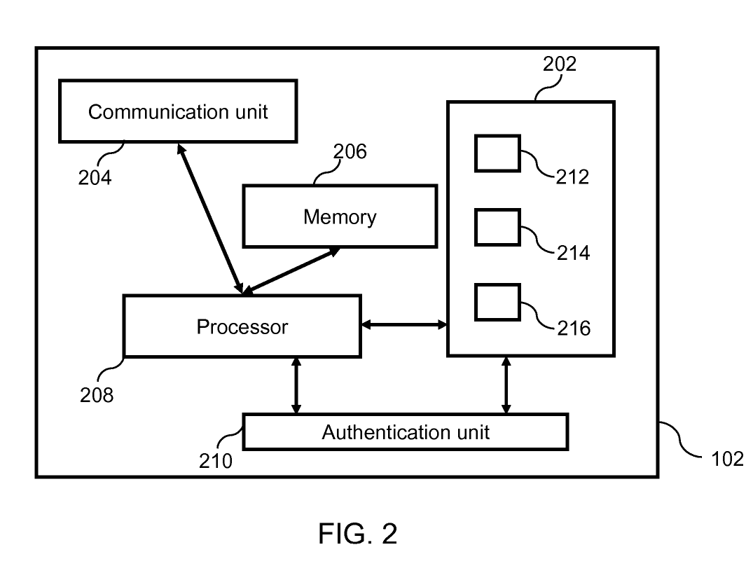

FIG. 2 illustrates a block diagram of the server 102, in accordance with an embodiment of the present invention. The server 102 includes a database 202, a means for communicating, hereinafter referred to as a communication unit 204, a memory 206, a processor 208, and an authentication unit 210. The database 202 is shown to include encrypted biometric profiles 212, 214, and 216; however, the database 202 may include further encrypted biometric profiles, each of which corresponds to a user. The biometric profiles 212, 214, and 216, are each encrypted using a unique key of a respective user. The server 102 communicates with one or more user devices through the communication unit 204. Examples of the communication unit 204 include, but are not limited to, an infrared communication unit, a Bluetooth communication unit, a radio frequency communication unit, a wireless local area network (WLAN) communication unit, a cellular network communication unit, and a modem. The memory 206 stores keys and biometric samples of one or more users, received from the corresponding user devices. Examples of the biometric samples include, but are not limited to, fingerprints, voice patterns, eye retina patterns, iris patterns, and facial patterns. In an embodiment of the present invention, the memory 206 also stores user identification codes of the one or more users, which are received from the corresponding user devices. A user identification code is a unique identifier associated with the user.

The processor 208 is capable of accessing the database 202 and the memory 206. The processor 208 selects an encrypted biometric profile corresponding to a user and decrypts the selected encrypted biometric profile using the corresponding key, to yield an unencrypted biometric profile. For example, the encrypted biometric profile 212 corresponds to the user device 104. In some embodiments of the present invention, the encrypted biometric profile of the user is selected from the database 202 using an identification code sent to the server 102 by the user device 104. The server 102 is capable of discarding the unencrypted biometric profiles, the keys, and the biometric samples of the one or more users, after the users have been authenticated. The authentication unit 210 is capable of authenticating the one or more users. In an embodiment of the present invention, the authentication unit 210 can authenticate the one or more users using the corresponding biometric samples and the unencrypted biometric profiles. The one or more user devices may be granted (may gain) access to the data after successful authentication of the corresponding one or more users.

In an embodiment of the present invention, a portion of the data is stored in a second server 103. The one or more user devices may be granted secure access to the portion of the data on the second server 103 by the server 102 after the successful authentication of the one or more users.

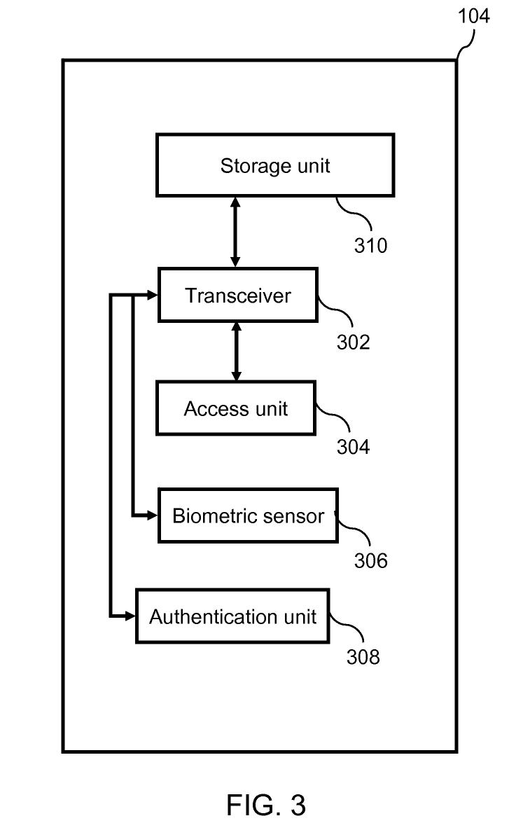

FIG. 3 illustrates a block diagram of the user device 104, in accordance with various embodiments of the present invention. The user device 104 includes a transceiver 302 and a means for accessing data, henceforth referred to as an access unit 304. The transceiver 302 is a functional unit of the user device 104 that is configured to transmit the key and the biometric sample of the user to the server 102. The access unit 304 is a functional unit of the user device 104 that is configured to access data on the server 102. The user device 104 also includes a biometric sensor 306, an authentication unit 308, and a storage unit 310. The transceiver 302 is operatively coupled to the storage unit 310 and the biometric sensor 306. The transceiver 302 is also operatively coupled to the access unit 304 and the authentication unit 308. The storage unit 310 stores the key of the encrypted biometric profile of the user. The key is transmitted through the transceiver 302 to the server 102. In an embodiment of the present invention, in addition to the key, a unique user identification code that is associated with the user is also stored in the storage unit 310 and is also transmitted through the transceiver 302 to the server 102. The biometric sensor 306 is a functional unit of the user device 104 that receives the biometric sample of the user. Although the biometric sensor 306 is shown to be present in the user device 104, the biometric sensor 306 may be coupled to either the user device 104 or the server 102. The biometric sample of the user is transmitted through the transceiver 302 to the server 102 for authentication of the user.

In an embodiment of the present invention, the authentication unit 308 authenticates the server 102 before the key is transmitted to the server 102. The access unit 304 accesses the data after successful authentication of the user device 104.

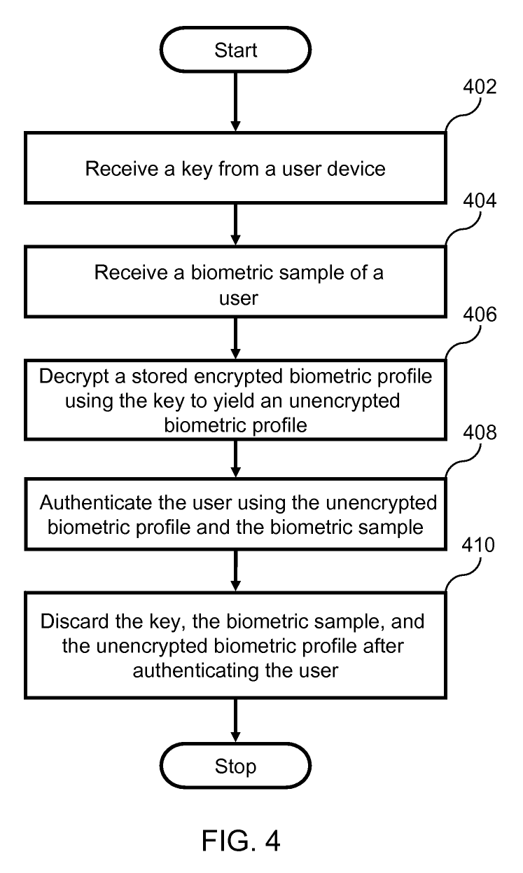

FIG. 4 is flowchart illustrating a method for managing secure access to data by a user in a network, in accordance with an embodiment of the present invention. At step 402, a key corresponding to the user may be transmitted by a user device 104 and received by the server 102. In an embodiment of the present invention, the server may also receive from the user device 104 a user identification code associated with the user. In some embodiments of the present invention, the user device validates the authenticity of (authenticates) the server before transmitting the key. For example, the user device 104 authenticates the server 102 before transmitting the key.

At step 404, a biometric sample of the user may be transmitted by the user device 104 and received by the server 102. At step 406, the encrypted biometric profile corresponding to the user is decrypted by the server by using the key, to yield an unencrypted biometric profile. For example, the processor 208 decrypts the encrypted biometric profile 212 corresponding to the user of the user device 104 by using the key, to yield an unencrypted biometric profile. In an embodiment of the present invention, the selection of encrypted biometric profile from the database 202 may be based on the user identification code.

At step 408, the user may be authenticated by an authentication unit 210 of the server 102. In an embodiment of the present invention, the authentication unit 210 may authenticate the user based on the biometric sample of the user and the unencrypted biometric profile. The authentication unit 210 may compare the biometric sample of the user with the unencrypted biometric profile for authentication using existing methods. The user device 104 may be granted access to the data by the server when the biometric sample of the user is found to be an adequate match to the unencrypted biometric profile through means well understood to those of normal skill in the art. In an embodiment of the present invention, the server grants the user device access to a portion of the data that is stored on a second server. For example, the server 102 grants the user device 104 secure access to the portion of the data on the second server 103 after the successful authentication of the user of the user device 104.

At step 410, the unencrypted biometric profile, the key and the biometric sample of the user are discarded by the server. For example, the server 102 discards the key, the sample biometric profile, and the unencrypted biometric profile after authentication of the user of the user device 104.

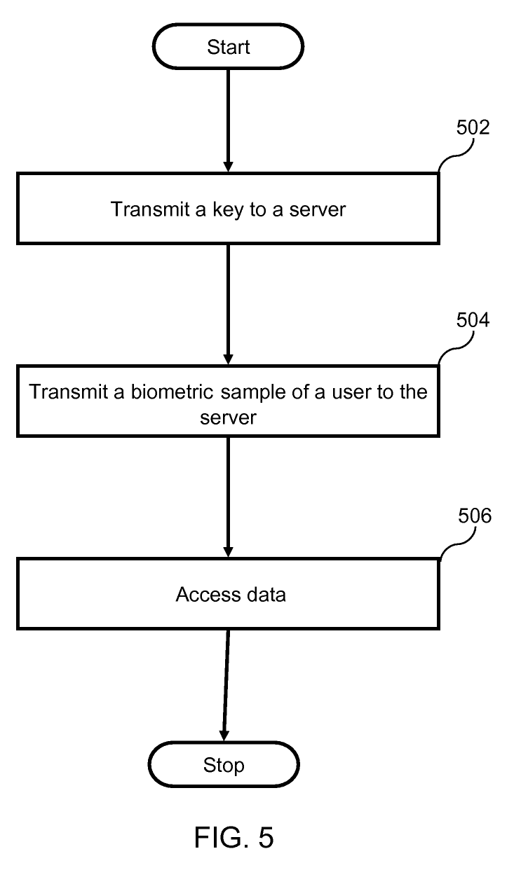

FIG. 5 is a flowchart illustrating a method for securely accessing data by a user device, in accordance with an embodiment of the present invention. At step 502, a key is transmitted by the user device to the server. For example, the transceiver 302 of the user device 104 transmits the key to the server 102. In an embodiment of the present invention, the user device 104 may authenticate the server 102 before the key is transmitted by the transceiver 302. In some embodiments of the present invention, a user identification code associated with the user is also transmitted to the server. For example, the transceiver 302 transmits the user identification code associated with the user to the server 102.

At step 504, a biometric sample is transmitted by the user device to the server. For example, the transceiver 302 transmits the biometric sample of the user that is received by the biometric sensor 306, to the server 102.

At step 506, the user device accesses the data after successful authentication of the user. For example, the access unit 304 accesses the data after successful authentication of the user of the user device 104 by the server 102. In an embodiment of the present invention, a portion of the data stored on a second server is accessed by the user device. For example, the access unit 304 of the user device 104 accesses the portion of the data that is present on the second server 103, after successful authentication of the user.

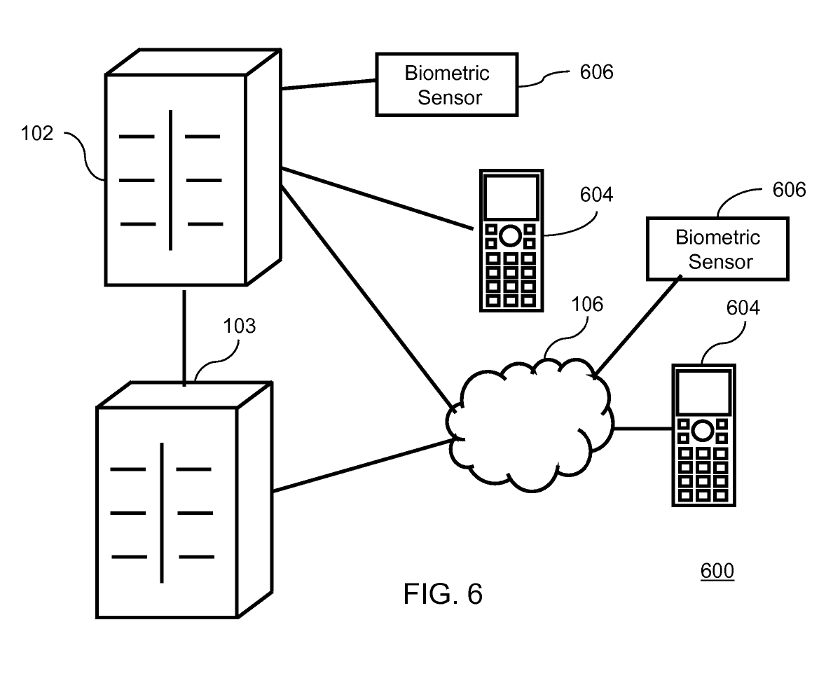

FIG. 6 illustrates an environment 600, where various embodiments of the present invention can be practiced. The environment 600 includes at least one server 102, a biometric sensor 606, which may be any of the types described herein above, and a user device 604. The user device 604 and the biometric sensor 606 may be linked to the server 102 by a communication link 106 or may be connected directly, such as by a cable. Other servers may be linked to server 102, as exemplified by second server 103. The user device 604 and/or the biometric sensor 606 may be connected to server 102 through another server, such as second server 103. The user device 604 may be any of the types of user devices described with reference to user device 104. Examples of the communication link 106 include, but are not limited to, a wireless communication link, a cellular link, and the Internet. The user devices 604 and biometric sensors 606 interact with the server 102 to determine access to data stored on the server 102. Embodiments of the present invention operate substantially the same as described herein above except that the biometric sample is provided to one of the biometric sensors 604, and the user devices need not include a biometric sensor 306 included in the user devices 104. In these embodiments, the receipt of the biometric sample is associated with the user of the user device 604. This may be accomplished by a variety of methods. In one instance, a biometric sensor 606 is always associated with only one user of the user device 604 present at a specified location (e.g., at an ATM terminal). In another instance, the association with the user is made only for the reception of one biometric sample, for example, by a time duration related to the receipt of a key from the user device 604. Thus, steps of receiving a key 402 from a user device, receiving a biometric sample 404 of the user, decrypting a stored encrypted biometric profile 406 using the key to yield an unencrypted biometric profile, authenticating 408 the user for secure access to the data using the unencrypted biometric profile and the biometric sample, and discarding 410 the key, the biometric sample, and the unencrypted biometric profile after authenticating the user are also accomplished in these embodiments.

As described above, various embodiments of the present invention enable the splitting of security-related information between a server and a user device. This information is necessary to access the data. The present invention increases security by distributing the information necessary for access to the data, between the server and the user device. The key is available only during transactions between the user device and the server. Similarly, a security breach of the user device does not allow an adversary to access the biometric information of the user, since this biometric information is stored on the server. The matching of the biometric sample with the corresponding encrypted biometric profile takes place at the secure server. As a result, the adversary with the compromised user device is unable to access the biometric information of the user, since the adversary is unable to supply a biometric sample of the user for authentication. The present invention provides additional security since the server discards the key, the biometric sample of the user, and the unencrypted biometric information of the user, obtained during the authentication, immediately after the authentication. Thus, a compromise of the server does not reveal any user's unencrypted biometric profile to the adversary.

It will be appreciated the modules described herein may be comprised of one or more conventional processors and unique stored program instructions that control the one or more processors to implement, in conjunction with certain non-processor circuits, some, most, or all of the functions of the modules described herein. The non-processor circuits may include, but are not limited to, a radio receiver, a radio transmitter, signal drivers, clock circuits, power source circuits, and user input devices. As such, these functions may be interpreted as steps of a method to perform accessing of a communication system. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein.

It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for managing secure access to data by a user in a network, the method comprising:
receiving a key from a user device;
receiving a biometric sample of the user;
decrypting a stored encrypted biometric profile using the key to yield an unencrypted biometric profile;
authenticating the user for secure access to the data using the unencrypted biometric profile and the biometric sample; and
discarding the key, the biometric sample, and the unencrypted biometric profile after authenticating the user.

2. The method according to claim 1 further comprising receiving a user identification code, wherein the user identification code is a unique identifier associated with the user, and the user identification code is used to select an encrypted biometric profile corresponding to the user from a database of at least one encrypted biometric profile.

3. The method according to claim 1 further comprising granting the user device an access to the data after a successful authentication of the user.

4. The method according to claim 3, wherein the method is performed within a first server and at least a portion of the data is in a second server, further comprising granting the user secure access to the portion of the data in the second server, after a successful authentication of the user.

5. The method according to claim 1, wherein receiving the biometric sample comprises receiving the biometric sample from the user through a biometric sensor.

6. The method according to claim 5, wherein the biometric sensor is coupled to one of the user device and a server that performs the step of receiving the biometric sample.

7. A method for managing a secure access to data by a user device of a user in a network, the method comprising:
transmitting a key to a server; and
transmitting a biometric sample of the user to the server.

8. The method according to claim 7 further comprising transmitting a user identification code to the server, wherein the user identification code is a unique identifier associated with the user.

9. The method according to claim 7 further comprising authenticating the server.

10. The method according to claim 7 further comprising receiving the biometric sample from the user through a biometric sensor.

11. The method according to claim 10, wherein the biometric sensor is coupled to one of the user device and the server that performs the step of receiving the biometric sample.

12. The method according to claim 7 further comprising gaining an access to the data after a successful authentication of the user by the server.

13. A server for managing secure access to data in a network, the server comprising:
a means for communicating with a user;
a memory, wherein the memory stores a key received from the user, and a biometric sample received from the user;
a database of at least one encrypted biometric profile;
a processor capable of accessing the memory and the database of at least one encrypted biometric profile, wherein the processor decrypts the encrypted biometric profile corresponding to the user from the database of at least one encrypted biometric profile using the key received from the user to yield an unencrypted biometric profile; and
an authentication unit capable of authenticating the user, wherein the authentication unit authenticates the user using the biometric sample received from the user and the unencrypted biometric profile.

14. The server according to claim 13, wherein the memory further stores a user identification code received from the user, the user identification code used by the processor to select the encrypted biometric profile corresponding to the user from the database of at least one encrypted biometric profile.

15. The server according to claim 13, wherein the unencrypted biometric profile, the key, and the biometric sample are discarded after the user has been authenticated.

16. The server according to claim 13, wherein the user device is granted an access to the data after a successful authentication of the user.

17. The server according to claim 13, wherein the user device is granted secure access to a portion of the data in a second server after a successful authentication of the user.

18. A user device comprising:
a transceiver configured to transmit a key and a biometric sample of a user to a server for authentication of the user; and
a means to access data after a successful authentication of the user by the server.

19. The user device according to claim 18, wherein the transceiver is configured to transmit a user identification code, further wherein the user identification code is a unique identifier associated with the user.

20. The user device according to claim 18 further comprising a biometric sensor operatively coupled to the transceiver, wherein the biometric sensor receives the biometric sample of the user.

21. The user device according to claim 18 further comprising an authentication unit, wherein the authentication unit validates the authenticity of the server.

22. The user device according to claim 18 further comprising a storage unit, wherein the storage unit stores the key.
